(19) United States
(12) Patent Application Publication
(10) Pub. No.: US 2020/0346948 A1
(43) Pub. Date: Nov. 5, 2020

(54) METHOD FOR THE ULTRAVIOLET STABILIZATION OF CHLORINE DIOXIDE IN AQUEOUS SYSTEMS

(71) Applicant: Roy W. Martin, Downers Grove, IL (US)

(72) Inventor: Roy W. Martin, Downers Grove, IL (US)

(73) Assignee: Truox, Inc., McClellan, CA (US)

(21) Appl. No.: 16/501,567

(22) Filed: May 1, 2019

(51) Int. Cl. C02F 1/32; C02F 1/76

(52) U.S. Cl. CPC C02F 1/32; C02F 2103/42; C02F 1/76

(57) ABSTRACT

Disclosed is a method for treating an aqueous system exposed to the sunlight with chlorine dioxide while inhibiting the UV degradation of chlorine dioxide.

### FIELD OF INVENTION

This invention relates to methods and compositions for enhanced sanitation and oxidation of aqueous solutions, such as aquatic facilities, and methods for their use.

### BACKGROUND OF THE TECHNOLOGY

Aquatic facility popularity has risen dramatically over the last few decades. This is especially evident in the area of recreational water exemplified by Water Parks and development of feature pools at Park Districts and resorts. To ensure that the aquatic facilities can be enjoyed safely, the water must be treated to reduce or eliminate various pathogens such as bacteria, viruses and parasitic organisms.

Recreational Water Illness (RWI) is a term used by the Center for Disease Control and Prevention (CDC) to describe the various illnesses contracted by humans during exposure to aquatic facilities such as Water Parks, swimming pools and the like.

Standard concentrations of chlorine used to treat recreational water (typically 1-3 mg/l as Cl₂) are sufficient to achieve a high rate of kill of most microbiological organisms introduced to the water of aquatic facilities. According to the CDC, E. coli, Norovirus, Giardia and other microbiological organisms account for no more than 20% of all RWI incidences combined. However, Cryptosporidium parvum accounts for nearly 80% of all reported RWI incidences in the United States. The high incidence of RWI attributed to Cryptosporidium parvum is the result of its high tolerance to chlorine.

To illustrate the level of chlorine tolerance, exposing E. coli to 1 mg/l of chlorine will typically achieve a 6-log kill in less than 1 minute. This equates to a Ct value of 1 mg-min/ltr. In contrast, the CDC reports it requires at Ct value of 15,600 mg-min/ltr to achieve a 3-log kill of Cryptosporidium parvum. This would require 40 mg/l of chlorine for 6.5 hours. As a result, the CDC reported Cryptosporidium parvum can survive in the water of an aquatic facility treated with normal levels of chlorine for 10 days, potentially exposing thousands of visitors over that period.

Cryptosporidium parvum (“Crypto”) contamination of an aquatic facility is the result of fecal discharge into the water by a person or animal infected.

To address this problem, the industry has implemented a treatment approach known as hyperchlorination. The hyperchlorination process requires isolating the aqueous system from human contact and treating with high concentrations of chlorine (i.e. 40 mg/l as Cl₂). At this concentration, it requires at least 6.5 hours of reaction time to achieve a 3-log kill based on the 3-log 15,600 mg·min/ltr Ct value, and 8.5 hours with 15 mg/l of cyanuric acid (UV stabilizer) based on CDC guidelines.

The economic impact to commercial water parks and pools that must close and often return admittance fees is devastating.

A new method for inactivating Crypto is needed to provide rapid remediation of the aqueous system in an expeditious manner to allow for prompt reopening to patrons.

### SUMMARY OF THE INVENTION

The referenced cyclic process provides for a means of in-situ generation of chlorine dioxide that is extremely useful in accelerating the inactivation of Crypto. However, while the cyclic process offers many benefits over existing methods for killing Crypto, it does require time to generate the chlorine dioxide. Furthermore, the exposure of chlorine dioxide to sunlight comprising ultraviolet light (also referred to as “UV”) quickly decomposes the chlorine dioxide generated by the cyclic process.

A method has been developed to accelerate the generation of chlorine dioxide during normal daylight hours when most recreational water facilities are being visited by exploiting the benefits of sunlight's UV to accelerate the generation of chlorine dioxide.

Addition of chlorite donor to the aqueous system exposed to sunlight results in generation of chlorine dioxide by ultraviolet decomposition of chlorite anions according to the proposed stoichiometry:

3ClO₂⁻+H₂O+hv→Cl⁻+2ClO₂+2OH⁻+0.5O₂

This method of generating chlorine dioxide dramatically reduces the time required to produce chlorine dioxide in a large body of water common to water parks. However, as previously disclosed, the chlorine dioxide produced is susceptible to ultraviolet (UV) degradation. To reduce the rate of UV degradation of chlorine dioxide, UV absorption chemistry is applied to the aqueous system that absorbs UV in the same wavelength range as chlorine dioxide.

### BRIEF DESCRIPTION OF THE FIGURES

FIG. 1 shows the UV absorbance spectra of Disodium Distyrylbiphenyl Disulfonate (DDBD) at a concentration of 4 mg/l in distilled H₂O.

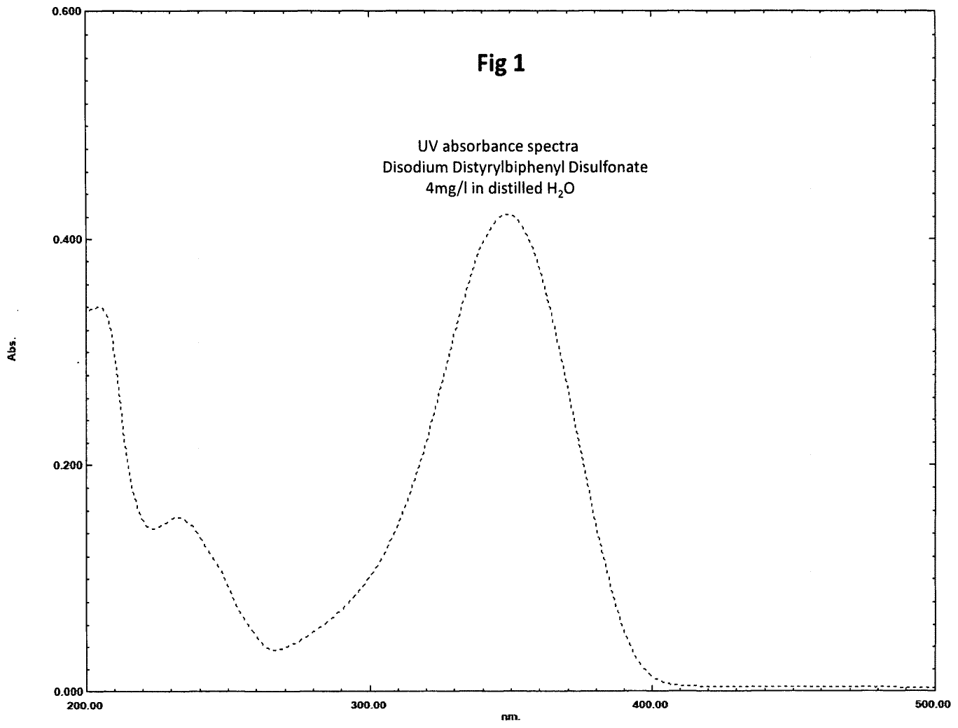

FIG. 2 illustrates how the UV spectra of chlorite anion overlays that of UV absorbent DDBD. The chlorite anion is provided virtually no UV protection.

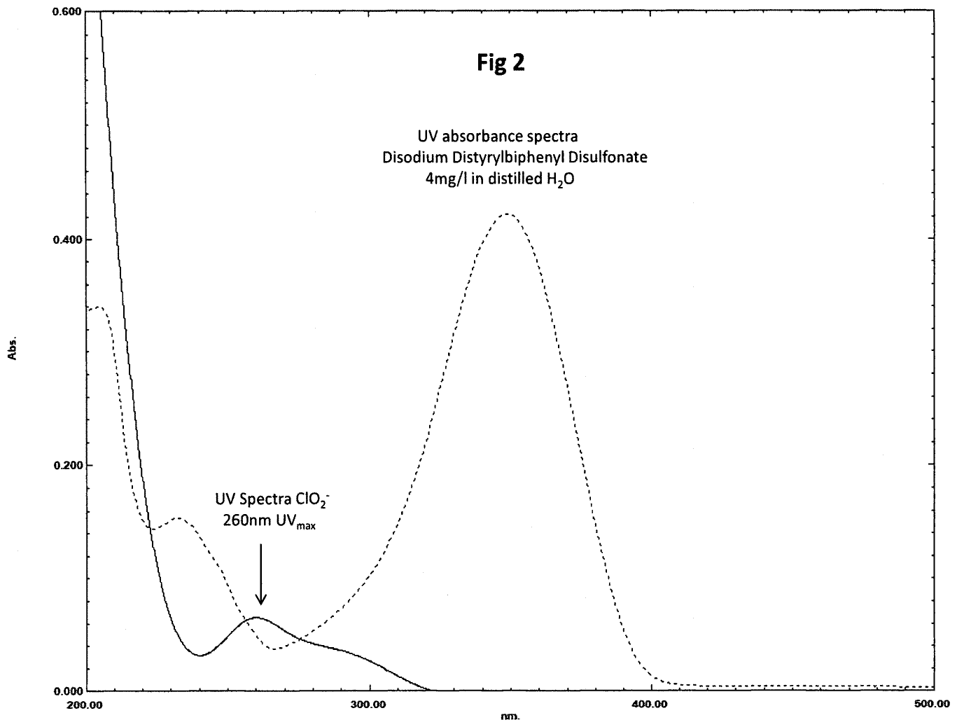

FIG. 3 illustrates the presence of chlorine dioxide with UVₘₐₓ at 360 nm wavelength. The overwhelming portion of the ClO₂ UV spectra is covered by the dome of UV protection provided by the DDBD.

FIG. 4 shows the increasing concentration of chlorine dioxide resulting from the cyclic process which remains protected by the dome of UV absorbent DDBD.

FIG. 5 illustrates the UV spectra of Avobenzone that effectively protects both the chlorite anion UVₘₐₓ of 260 nm as well as the chlorine dioxide UVₘₐₓ at 360 nm.

FIG. 6 illustrates the cyclic process.

### DETAILED DESCRIPTION OF THE INVENTION

In one embodiment, disclosed is a method for treating an aqueous system with chlorine dioxide while exposed to sunlight, the method comprising: adding to the aqueous system an effective amount of UV absorbent and chlorine dioxide; inhibiting UV degradation of chlorine dioxide by absorbing UV with the UV absorbent; sustaining a chlorine dioxide concentration to obtain a Ct value, and wherein the Ct value is sufficient to achieve remediation.

In another embodiment, disclosed is a method for treating an aqueous system with chlorine dioxide while exposed to sunlight, the method comprising: adding to the aqueous system an effective amount of UV absorbent and chlorite donor; generating chlorine dioxide by UV decomposition of chlorite; inhibiting UV degradation of chlorine dioxide by absorbing UV with the UV absorbent; sustaining a chlorine dioxide concentration to obtain a Ct value, and

wherein the Ct value is sufficient to achieve remediation.

In yet another embodiment, disclosed is a method for treating an aqueous system with chlorine dioxide while exposed to sunlight, the method comprising: adding to the aqueous system an effective amount of UV absorbent and chlorite donor; generating chlorine dioxide using the cyclic process; inhibiting UV degradation of chlorine dioxide by absorbing UV with the UV absorbent; sustaining a chlorine dioxide concentration sufficient to obtain a Ct value, and wherein the Ct value is sufficient to achieve remediation.

### Prior Art:

U.S. Pat. Nos. 7,922,933, 7,927,509, and 7,976,725 which are herein incorporated by reference in their entirety, disclose a cyclic process for the in-situ generation of chlorine dioxide. The cyclic process utilizes bromide ions that are activated by an oxidant to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process.

U.S. Pat. Nos. 4,414,180 and 4,456,511 disclose a chlorine dioxide generator and method for generating chlorine dioxide gas from an aqueous solution of sodium chlorite through photochemical oxidation. The generator produces chlorine dioxide by exposing the sodium chlorite solution to UV radiation using a UV generating lamp to produce chlorine dioxide while continuously sparging the solution with gas to remove the chlorine dioxide before it is decomposed by the UV.

### Definitions:

As used herein the term “Ct value” is defined as the product of the average concentration of an oxidant (mg/l) and time (minutes) of exposure to the oxidant. For example, if the average chlorine dioxide concentration of ClO₂ is determined to be 2.2 mg/l over a 20 minute period of time, the Ct value is calculated by multiplying the average concentration of chlorine dioxide by the time.

Ct value=2.2 mg/l×20 min

Ct value=44 mg·min/l

The Ct value can be targeted based on laboratory and/or field studies to achieve the desired level of inactivation. Comparatively, low Ct values (i.e. Ct=1 mg·min/l) may achieve a 6-log reduction in bacteria like E. coli, while higher Ct values (i.e. Ct=90 mg·min/l) may be required to reduce a parasite like Cryptosporidium by 3-log.

As used herein, the term “free chlorine” is used with reference to a chlorine source that hydrolyses in the aqueous system to produce at least some portion of hypochlorous acid.

As used herein, the term “free bromine” is used with reference to the formation or presence of hypobromous acid and possibly some portion of hypobromite ions.

As used herein, the term “inactivation” is used with reference to the ability to deactivate, kill, or destroy microbiological organisms.

As used herein, the term “microbiological organisms” is used with reference to all forms of microbiological life forms including: parasites, bacteria, viruses, algae, fungus, and organisms encased in biofilms.

As used herein, the term “free halogen donor” is used with reference to a halogen source which acts as an active oxidizer when dissolved in water. Chlorine based free halogen donors form at least one of Cl₂, HOCl, and OCl⁻ (also referred to as free chlorine) when added to water, whereby the species formed is pH dependent. Bromine based free halogen donors form at least one of Br₂, HOBr, and OBr⁻ (also referred to as free bromine), again the species being pH dependent.

As used herein, the term “aquatic facility” is used with reference to all structural components and equipment comprising an aqueous system used by humans for exercise, sports and/or recreation. Examples of aquatic facilities include but are not limited to: water parks, theme parks, swimming pools, spas, therapy pools, hot tubs and the like.

As used herein, the term “aqueous system” describes a body of water that can be treated using the disclosed invention. Examples of aqueous systems include recreational water, cooling towers, cooling ponds and wastewater.

As used herein, “recreational water” is water used by humans for various activities such as swimming, exercise, water sports, recreation, physical therapy and diving. Examples of aqueous systems comprising recreational water include: swimming pools, hot tubs, feature pools, spas, water-park rides, therapy pools, diving wells etc.

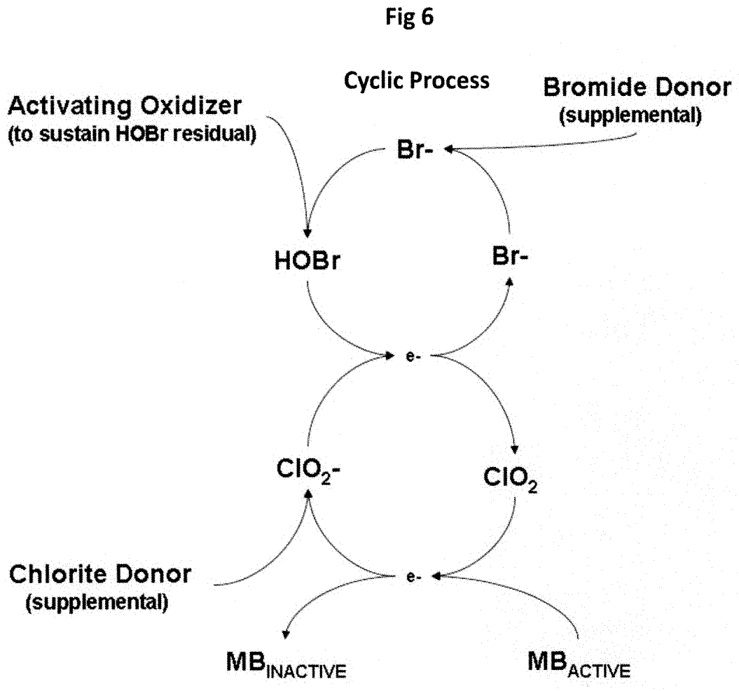

As used herein, the term “cyclic process” relates to the recycling of substantially inert anions comprising bromide and chlorite into their oxyhalogen surrogates, exemplified by hypobromous acid and chlorine dioxide respectfully (FIG. 6).

As used herein, the term “chlorite anion donor” and “chlorite donor” is a compound that comprises an alkali metal salt comprising chlorite anions ClO₂⁻, chlorine dioxide, or any convenient direct or indirect source of chlorite anions. For example, chlorine dioxide can indirectly produce chlorite due to reduction in an aqueous system. Sodium chlorite directly supplies chlorite anions.

As used herein, the term “chlorite anion” (also referred to as “chlorite”) comprises chlorite having the general formula ClO₂⁻.

As used herein, the term “recycled” means at least some portion of the recovered bromide anions and chlorite anions are regenerated to their respective oxyhalogen compounds, followed by reduction back to their respective anions, and where the process is repeated.

As used herein, the term “Cryptosporidium” is used to represent any form of parasitic microbiological organism from the family of Cryptosporidium. An example of Cryptosporidium is Cryptosporidium parvum (also referred to as C. parvum, C. parvum and Cryptosporidium parvum). Other examples of Cryptosporidium include but are not limited to: C. hominis, C. canis, C. felis, C. meleagridis, and C. muris. It is to be noted that inclusion or exclusion of italic characters or print when referring to Cryptosporidium or any of its many variants does not in any way detract from its intended descriptive meaning.

As used herein, the term “microbiological organisms” is used with reference to all forms of microbiological life including: parasites, bacteria, viruses, algae, fungus, and organisms encased in biofilms.

As used herein, “parasites” includes any species of organism including Cryptosporidium, Giardia and Ameba that can be transferred to humans by water and cause waterborne parasitic disease in humans.

As used herein, the term “inactivation” is used with reference to the ability to deactivate, kill, or destroy microbiological organisms.

As used herein, “remediation” is used with reference to achieving the Ct value necessary to obtain at least a 6-log reduction (kill) of bacteria &/or at least a 3-log reduction (kill) of parasites.

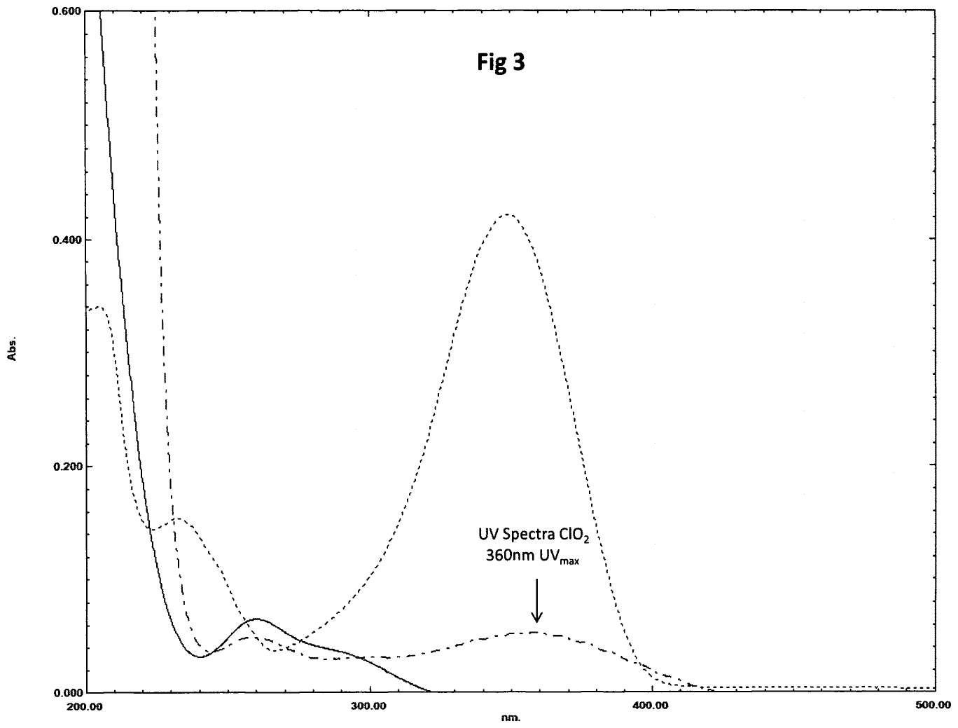

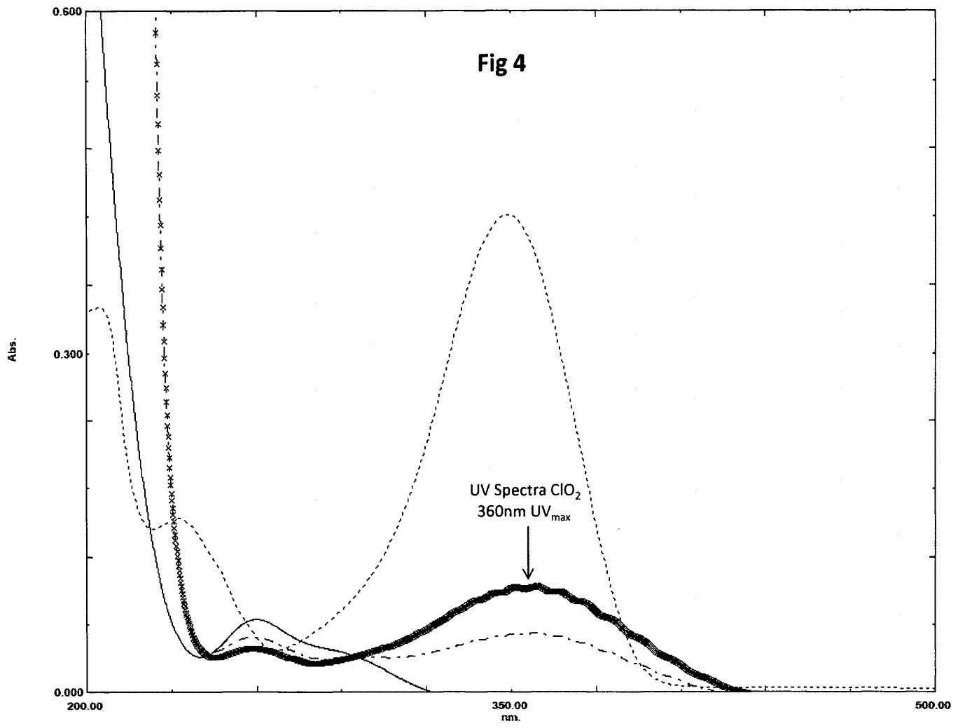

As used herein “UV absorbent” describes chromophores capable of absorbing UV in the wavelengths that include at least some portion of the chlorine dioxide UV spectrum. The UV absorbent absorbs ultraviolet radiation in the range of wavelengths that include greater than 25%, preferably greater than 50% and most preferably greater than 75% of the chlorine dioxide UV absorbance spectrum. Referring to FIGS. 3 and 4, the UV absorbance spectrum of DDBD clearly encompasses the majority of chlorine dioxide UV absorbance spectrum.

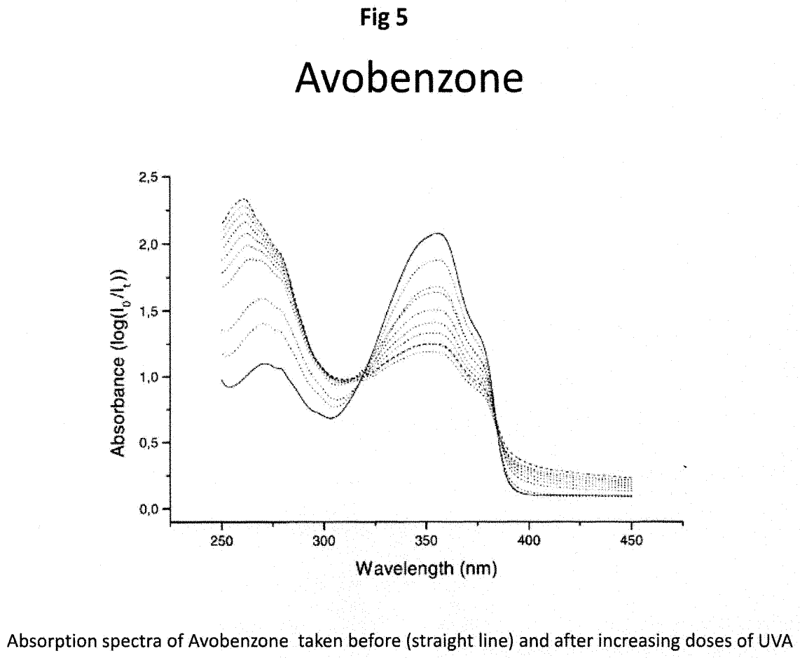

As used herein “chlorite-UV absorbent” comprise chromophores that absorb ultraviolet radiation in the range of wavelengths that include greater than 25%, preferably greater than 50% and most preferably greater than 75% of the chlorite UV absorbance spectrum. Referring to FIG. 5, the UV absorbance spectrum of Avobenzone clearly encompasses the majority of chlorite UV absorbance spectrum.

As used herein “effective amount of UV absorbent” is the concentration of UV absorbent needed to sufficiently inhibit UV degradation (also referred to as photo-degradation) of chlorine dioxide in order to achieve remediation.

### Discussion

Sunlight comprises electromagnetic radiation in various wavelengths ranging from infrared, visible and ultraviolet light (UV).

UV absorbents can absorb UV in a range of wavelengths. UV can be categorized into wavelength based groups. The groups of interest as they pertain to this disclosure include: UVA (315-400 nm), UVB (280-315 nm) and UVC (100-280 nm).

The amount of UV absorbent needed to obtain adequate UV protection depends on the UV absorbents used. As illustrated in FIGS. 3 and 4, the amplitude of the absorbance spectrum provided by 4 mg/l of DDBD was approximately 4-times greater than the amplitude of the chlorine dioxide absorbance. This illustrates that even at relatively low concentrations DDBD can provide significant protection from UV degradation of chlorine dioxide resulting from exposure to sunlight. If greater protection is desired, higher concentrations of DDBD and/or other UV absorbents can be applied.

Another factor to consider when determining the amount of UV absorbent is the concentration of chlorine dioxide desired, the contact time required to achieve the Ct value necessary to remediate the aqueous system and the intensity of the UV.

Referring to FIG. 4, the data illustrates the amplitude of the UV absorbance for chlorine dioxide (360 nm is the UVₘₐₓ for chlorine dioxide) increases with concentration. So if higher concentrations of chlorine dioxide are desired to reduce the time required to achieve the Ct value, it may be necessary to increase the concentration of UV absorbent to adequately protect the chlorine dioxide from the sun's UV.

It is desirable to apply sufficient UV absorbent so that its UV absorbance amplitude is greater than the amplitude of the chlorine dioxide UV absorbance. Preferably, the UV absorbent's amplitude is at least 2-times the amplitude of the chlorine dioxide absorbance amplitude, more preferred at least 3-times and most preferred at least 4-times the amplitude of the UV absorbance of chlorine dioxide.

UV absorbents comprise organic chromophores that absorb various wavelengths of light in the UV spectrum. Common examples of UV absorbents are sunscreens and optical brighteners used in laundry treatments to improve whitening of fabrics. The range of UV absorbance can vary significantly from compound to compound. Furthermore, the solubility of the compound, stability to oxidizers (e.g. chlorine and chlorine dioxide) as well as UV degradation varies from compound to compound. The selection of the UV absorbents can be altered and blended to take advantage of the differences.

For example, as illustrated in FIG. 5, avobenzone undergoes photo-degradation when exposed to UVA. When avobenzone is applied to recreational water to protect chlorine dioxide during a remediation treatment, the UV absorbent will provide protection to the chlorine dioxide whether directly applied or generated in-situ (cyclic process &/or UV degradation of chlorite) in the aqueous system. However, under conditions of continued bombardment from UVA resulting from exposure to sunlight, the avobenzone with degrade, preventing accumulation resulting from ongoing remediation treatments. This would be considered an advantage since it provides the needed benefit to allow for the remediation of the aqueous system by protecting the chlorine dioxide, but is then degraded post remediation treatment.

The solubility of UV absorbents ranges from very water soluble to virtually insoluble in water. For example, DDBD is water soluble and will readily dissolve in aqueous solutions. However, avobenzone solubility is reported to be 2.2 mg/l. While 2 mg/l of avobenzone will provide good UV absorbance in many applications, its limited solubility offers greater potential. Forming a hydrophobic film of UV absorbent on top of the aqueous system provides a means of inhibiting UV degradation of chlorine dioxide &/or chlorite in the water by absorbing the UV on the water's surface before it penetrates the water. Furthermore, this method greatly reduces the interaction between oxidizers in the water and the UV absorbent so the UV absorbents not resistant to oxidizers like chlorine dioxide will not experience as much chemical degradation. Further still, this method of application may reduce the overall concentration of UV absorbent by coating only the surface of the water with a comparatively high concentration of UV absorbent rather than having to treat the entire volume of water.

The use of UV absorbents is also beneficial while incorporating the cyclic process for the in-situ generation of chlorine dioxide. The cyclic process utilizes bromide ions that are activated by an oxidant such as chlorine or potassium monopersulfate to produce free bromine. The free bromine oxidizes chlorite ions producing chlorine dioxide. Chlorine dioxide inactivates microbiological organisms (i.e. Cryptosporidium). During this process the free bromine and at least some portion of the chlorine dioxide are reduced back to bromide ions and chlorite ions respectively which are recycled back to free bromine and chlorine dioxide utilizing the cyclic process. By inhibiting the UV degradation of chlorine dioxide and chlorite, the cyclic process can be carried out during daytime hours without rapid degradation of the chlorine dioxide and accelerated UV degradation of the chlorite. The cyclic process is therefore able to provide an continued and relatively consistent concentration of chlorine dioxide throughout the day.

Mixtures of UV absorbents can be blended together to provide the desired UV absorbance as well as desired features already disclosed. Suitable solvents can be selected for form solutions, slurries, emulsions and the like. The consistency and solubility is limited by the formulator. Depending on the UV absorbents solubility profile, non-limiting examples of solvents include: water, methanol, ethanol, isopropyl alcohol, acetone, DMSO, mineral oil and the like. Surfactants can be used to form emulsions. Examples of surfactants include ethoxylated alcohols, ethylene and propylene block copolymers and the like.

Non-limiting examples of UV absorbents include: Disodium Distyrylbiphenyl Disulfonate (DDBD), 2,4-dihydroxybenzophenone, 2,2′,4,4′-tetrahydroxybenzophenone, 2-hydroxy-4-methoxybenzophenone, 5-benzoyl-4-hydroxy-2-methoxy monosodium salt, 5-methyl-2-(1-methyl-ethyl)-2-aminobenzoate, 2-Ethoxyethyl-para-methoxycinnamate, para-methoxyhydroxycinnamate, Amyl-4-methoxycinnamate, Amyl para-N,N-dimethylaminobenzoate, ethyl-4-bis(2-hydroxypropyl) aminobenzoate, 4,4′-Diamino-2,2′-stilbenedisulfonic acid, 4 4′-bis(benzoxazolyl)-cis-stilbene, 2 5-bis(benzoxazol-2-yl)thiophene.

It is claimed:

1. A method for treating an aqueous system with chlorine dioxide while exposed to sunlight, the method comprising: adding to the aqueous system an effective amount of UV absorbent and chlorine dioxide; inhibiting UV degradation of chlorine dioxide by absorbing UV with the UV absorbent; sustaining a chlorine dioxide concentration to obtain a Ct value, and
wherein the Ct value is sufficient to achieve remediation.

2. The method in accordance with claim 1, wherein remediation achieves at least a 6-log reduction of bacteria.

3. The method in accordance with claim 1, wherein remediation achieves at least a 3-log reduction of parasite.

4. The method in accordance with claim 3, wherein the parasite comprises Cryptosporidium.

5. The method in accordance with claim 3, wherein the parasite comprises Giardia.

6. The method in accordance with claim 3, wherein the parasite comprises Ameba.

7. The method in accordance with claim 1, wherein the aqueous system comprises recreational water.

8. A method for treating an aqueous system with chlorine dioxide while exposed to sunlight, the method comprising: adding to the aqueous system an effective amount of UV absorbent and chlorite donor; generating chlorine dioxide by ultraviolet decomposition of chlorite; inhibiting UV degradation of chlorine dioxide by absorbing UV with the UV absorbent; sustaining a chlorine dioxide concentration to obtain a Ct value, and wherein the Ct value is sufficient to achieve remediation.

9. The method in accordance with claim 8, wherein remediation achieves at least a 6-log reduction of bacteria.

10. The method in accordance with claim 8, wherein remediation achieves at least a 3-log reduction of parasite.

11. The method in accordance with claim 10, wherein the parasite comprises Cryptosporidium.

12. The method in accordance with claim 10, wherein the parasite comprises Giardia.

13. The method in accordance with claim 10, wherein the parasite comprises Ameba.

14. The method in accordance with claim 8, wherein the aqueous system comprises recreational water.

15. A method for treating an aqueous system with chlorine dioxide while exposed to sunlight, the method comprising: adding to the aqueous system an effective amount of UV absorbent and chlorite donor; generating chlorine dioxide using the cyclic process; inhibiting UV degradation of chlorine dioxide by absorbing UV with the UV absorbent; sustaining a chlorine dioxide concentration sufficient to obtain a Ct value, and wherein the Ct value is sufficient to achieve remediation.

16. The method in accordance with claim 15, wherein remediation achieves at least a 6-log reduction of bacteria.

17. The method in accordance with claim 15, wherein remediation achieves at least a 3-log reduction of parasite.

18. The method in accordance with claim 17, wherein the parasite comprises Cryptosporidium.

19. The method in accordance with claim 17, wherein the parasite comprises Giardia.

20. The method in accordance with claim 17, wherein the parasite comprises Ameba.

21. The method in accordance with claim 15, wherein the aqueous system comprises recreational water.
